(19) United States
(12) Patent Application Publication
(10) Pub. No.: US 2026/0335757 A1
(43) Pub. Date: Oct. 29, 2026

(54) Motorized Dual Sport Board

(71) Applicant: Aaron l. Greenwood, Twinfalls, ID (US)

(72) Inventor: Aaron l. Greenwood, Twinfalls, ID (US)

(21) Appl. No.: 19/193,281

(22) Filed: Apr. 29, 2025

(51) Int. Cl. A63C 17/12; A63C 17/00; A63C 17/01; A63C 17/14; A63C 17/26; B62D 21/18; B62D 27/02; B62D 51/02

(52) U.S. Cl. CPC A63C 17/12; A63C 17/0046; A63C 17/011; A63C 17/14; A63C 17/26; B62D 21/183; B62D 27/023; A63C 2203/12; A63C 2203/14; A63C 2203/20; A63C 2203/42; B62D 51/02

(57) ABSTRACT

A motor-powered duel sport board vehicle. With a front and rear tire/wheel. A motor mounted on the rear subframe above the rear tire/wheel connected to the rear axle with a chain and rear drive sprocket. The mainframe for standing or sitting is connected to the front steering damper and the rear steering damper, with front and rear springs, shocks left and right side. For steering, controllability, and suspension. Started with a battery connected to an electric starter or a kick starter. With a gas tank for fuel storage. A control bar connected to the rear subframe with throttle cable that connects the thumb throttle lever, a hydraulic brake system, a headlight, taillight, brakelight and turn signals. Leaning left or right to turn. Pulling up the shift linkage for higher gears pushing down on the shift linkage for lower gears.

### TECHNICAL FIELD

The present invention relates to dirt bikes, surf boards and skateboards.

You drive it like a surfboard, dirt bike.

### II. BACKGROUND PRIOR ART

Dirt bikes are well known. But a dirt bike while having a front and rear tire do not have a flat surface to stand on and are not able to be controlled or operated anything like this current embodiment (FIG.) 1

The relative patent for a dirt is.

For an electric dirt bike
USD735086s1
2014 Feb. 7 Application filed by Dyna Craft BSC inc
2014 Feb. 7 Priority U.S. Ser. No. 29/481,612
2014 Mar. 12 Assigned to Dyna Craft BSC inc
2014 Apr. 11 Priority+CA 156013
2015 Jul. 28 Application granted
2015 Jul. 28 Publication of us D735086S1
Status Active
2029 Jul. 28 Anticipated expiration

Skateboards are also well known. But a skateboard has little wheels and a small flat surface to stand on. Skateboards of any style or configuration do not have big enough motors or street legal safety equipment like hydraulic brakes, blinkers/turn signals. Can not travel fast enough to drive on highways. Also do not have large size tires to roll easily and safely over large objects.

The relative patent for a motorized skateboard is.
US684852782
2002 Oct. 8 Application filed by individual.
2002 Oct. 8 Priority to U.S. Ser. No. 10/266,837
2004 Apr. 8 Publication of us20040065494A1
2005 Feb. 1 Application granted
2005 Oct. 21 Adjusted Expiration
Status Expired-Fee Related

### SUMMARY OF INVENTION

In accordance multiple aspects of the invention have several advantages, presented in the following descriptions.
1. provide a low cost for affordable transportation.
2. giving you a larger platform to stand on for stability.
3. with large pneumatic tires that provide comfortability, handling and control at higher speeds or over large objects or jumps.
4. front and rear steering damper systems for better more controlled turning and providing added suspension.
5. front and rear steering suspension springs for a controlled steering for a suspension assisted means of travel.
6. a motor placed over the back tire for additional traction and to be able to have room for a much larger motor 50 cc, 65 cc, 85 cc, 125 cc, 250 cc, 500 cc, 750 cc, or higher if so desired.
7. a large volume gas tank for long-distance travel.
8. control bar for control of the entire vehicle in your hands.
   a. thumb throttle for accelerating and decelerating.
   b. hydraulic brake for slowing and stopping
   c. a tethered kill switch leash in case you fall off it disconnects and stops the motor from running. Turns it off.
   d. turn signal switch for signaling turning to other traffic.
9. a headlight for seeing and driving at night or dark.
10. taillight for other traffic to see you.
11. brake light for signaling stopping or slowing down with brake.
12. you ride it like it's a surfboard dirt bike.

### III. BRIEF DESCRIPTION OF DRAWINGS

FIG. 1 is a right-side view of the complete embodiment invention.

FIG. 2 is an exploded view of the front right half of the embodiment.

FIG. 3 is an exploded view of the rear right half of the embodiment. Which also shows rear stabilizer wheels for added stability.

FIG. 4 is a left side view of the complete embodiment which illustrates the rear subframe motor to drive sprocket on the axle for rotational energy.

FIG. 5 is an exploded view of the front left half of the embodiment which illustrates the front fork, suspension springs, steering damper, axle, tire and rim.

FIG. 6 is an expanded view of the left rear half of the embodiment.

FIG. 7 is a top view of the control bar that has the rear hydraulic brake lever, thumb throttle, turn signal switch and the safety kill switch tether.

FIG. 8 is a top view of FIG. 1.

FIG. 9 is a front view of the rear subframe, motor, and control panel.

FIG. 10 is a upper side view of FIG. 6. This expanded view shows the motor sprocket and chain to jackshaft sprocket to shaft to sprocket to chain configuration.

FIG. 11 is an upper side view of FIG. 3.

FIG. 12 is a front top view of FIG. 8.

FIG. 13 is a sketched view of FIG. 9 with reference lines and numerals roomed for clarity.

FIG. 14 is a bottom view of FIG. 8.

FIG. 15 is rear expanded bottom view of FIG. 8.

FIG. 16 is front expanded view of FIG. 8.

FIG. 17 is a right-side view of FIG. 1. With the reference lines and numerals removed for clarity.

FIG. 18 is a front right view of FIG. 1 with the reference lines and numerals removed for clarity.

FIG. 19A is a side view of the front fork steering damper system removed from the main frame and the tire, rim and axle removed to better illustrate the front fork steering damper system.

FIG. 19B is a view of the mechanical parts of the steering damper system.

FIG. 20A is a side view of the rear subframe and steering damper system removed from the main frame. With the motor, electrical, tire/rim and axle removed to better illustrate the rear subframe steering damper system.

FIG. 20B is a view of the mechanical parts of the steering damper system.

FIG. 21 is a view of the steering damper system fully assembled with the swivel actuating arm disconnected (not welded) to the front fork and or the rear subframe.

FIG. 22 is a side elevation view of the main frame and its structural components.

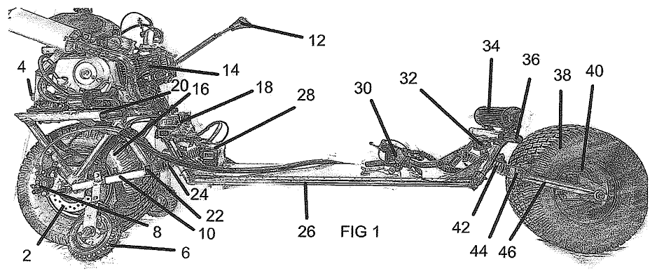

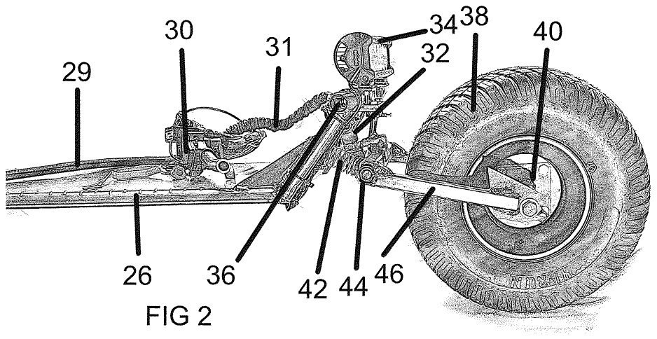

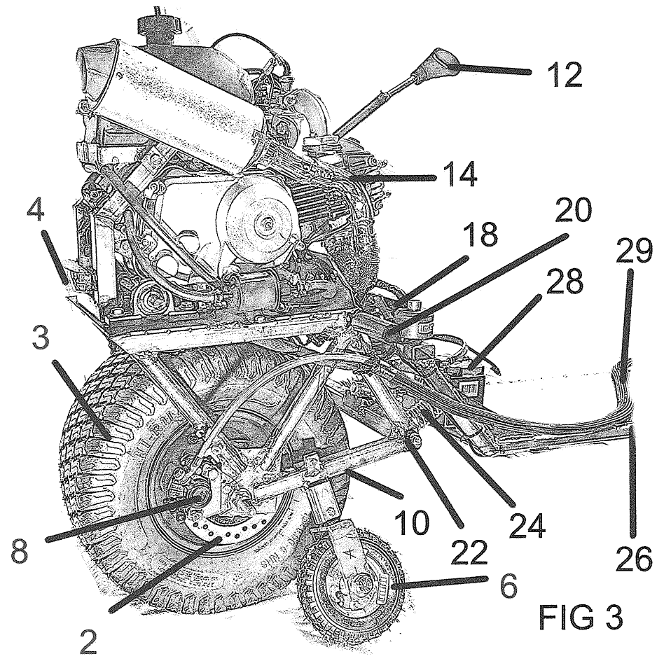

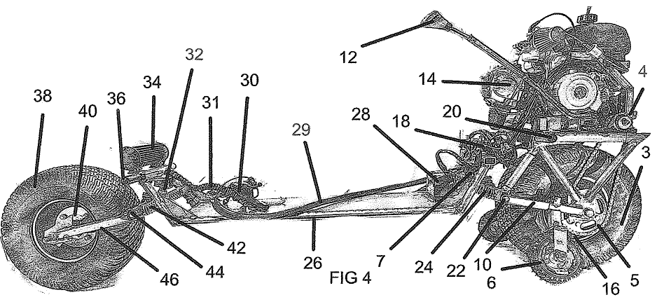

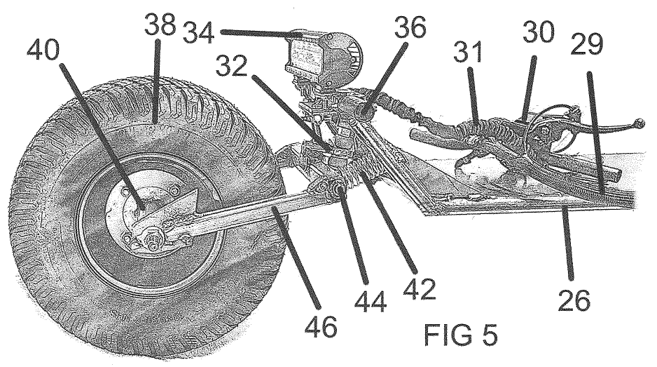

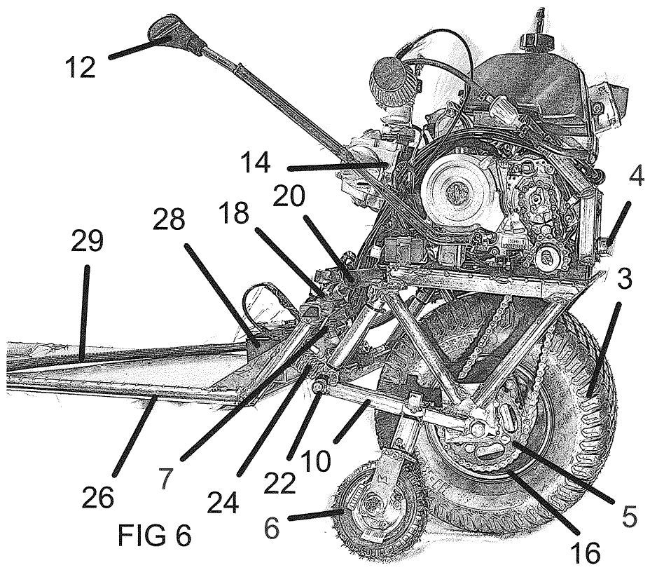

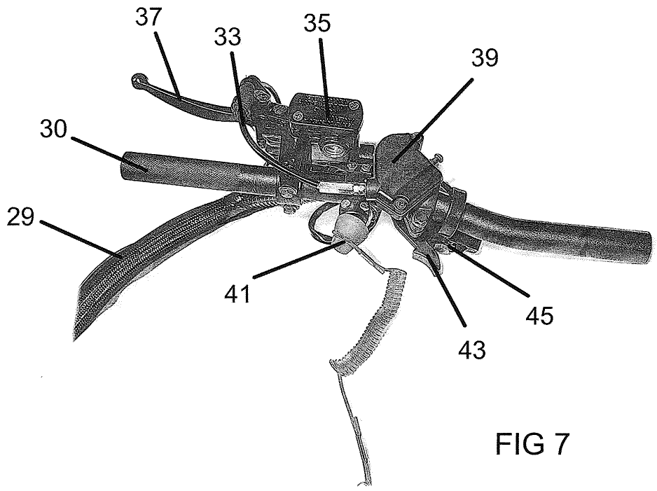

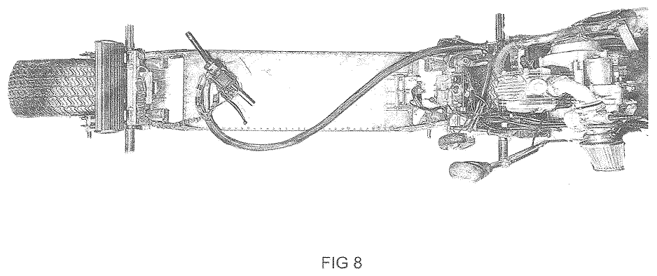

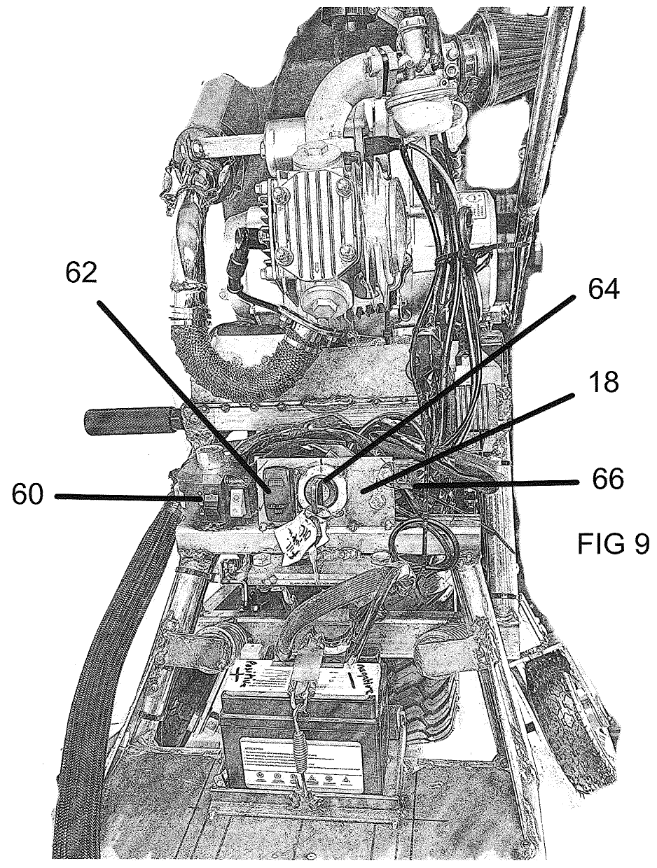

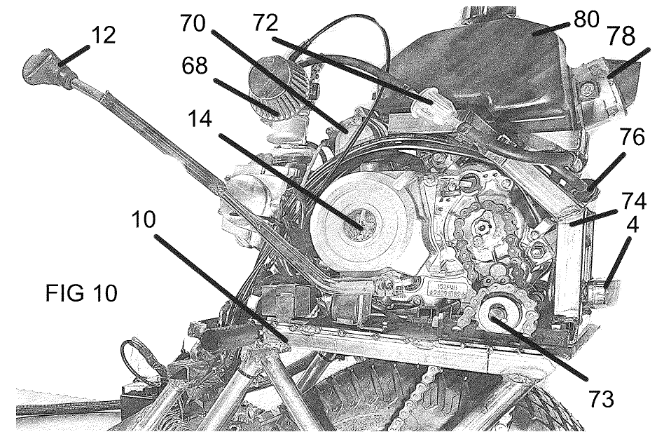

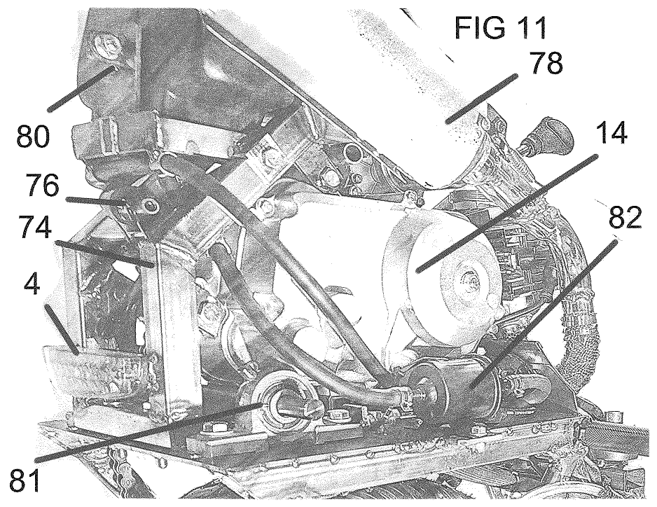

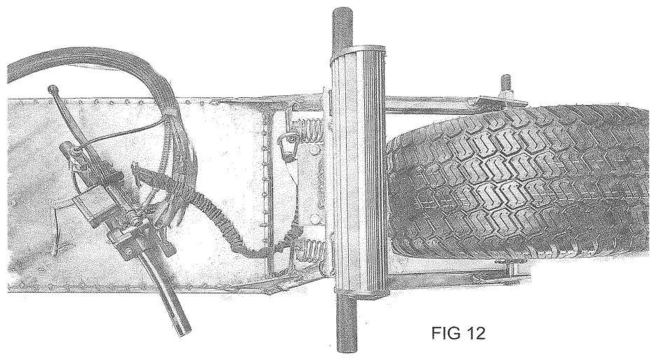

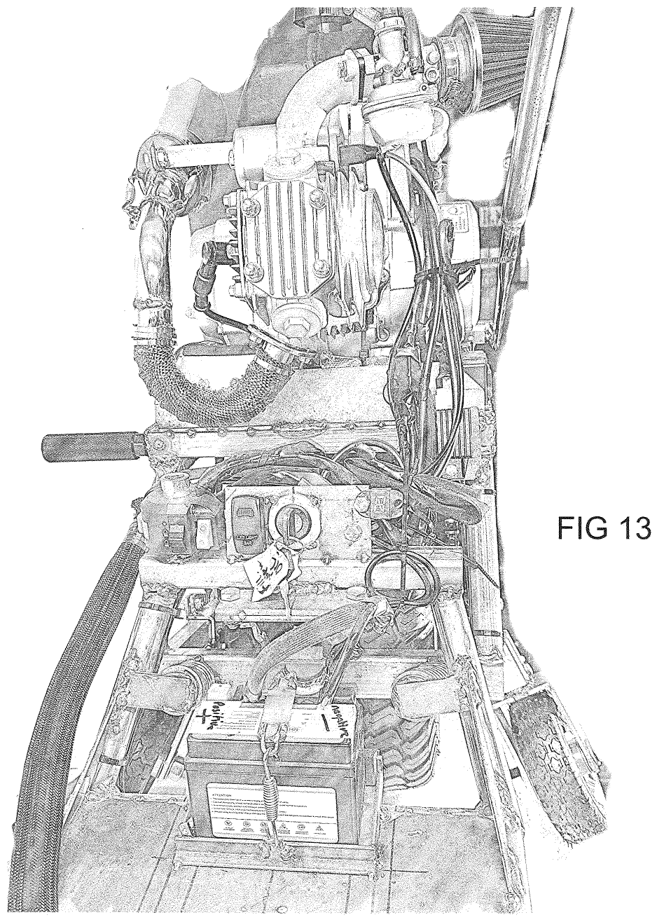

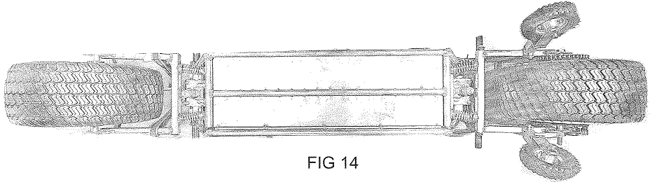

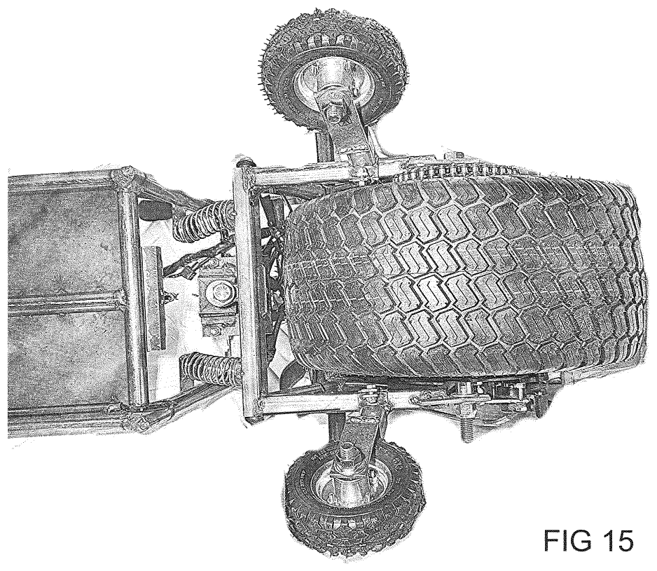

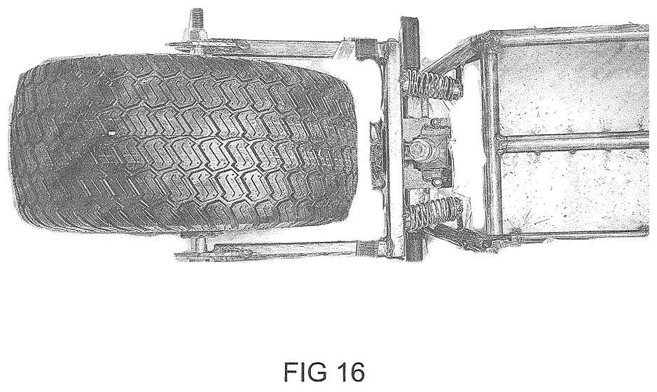

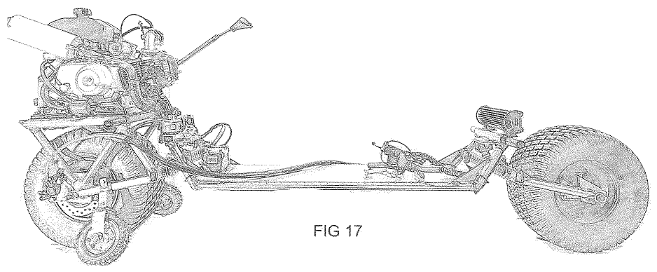

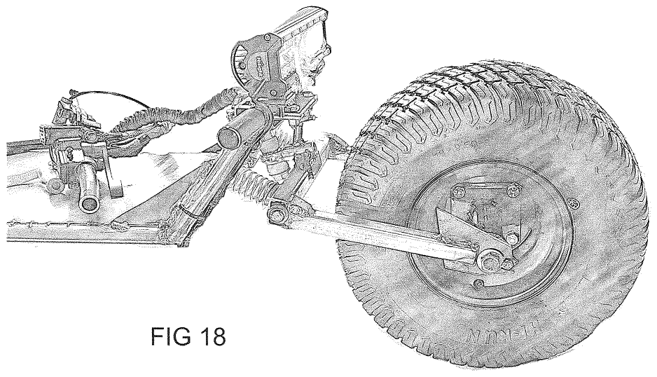

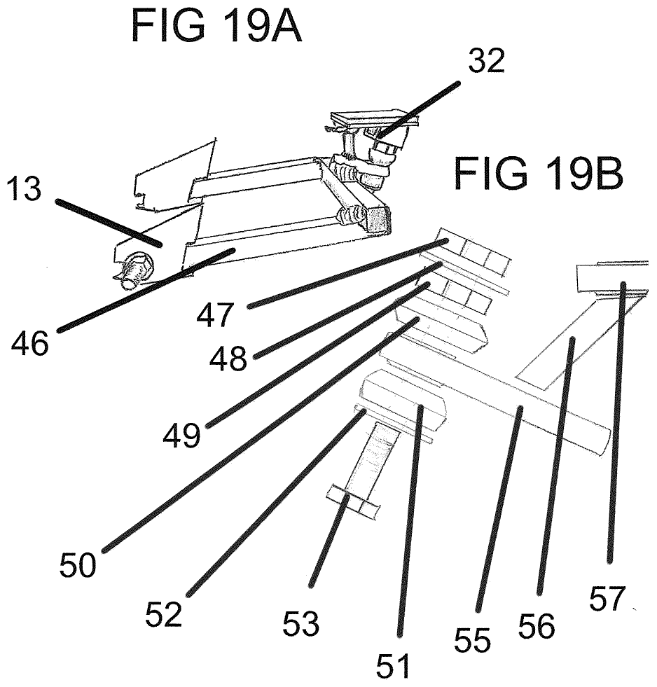

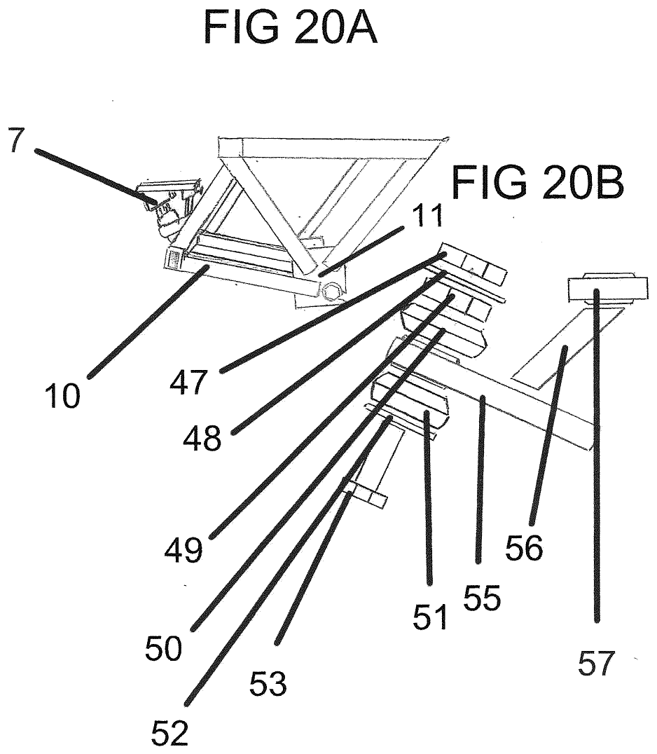

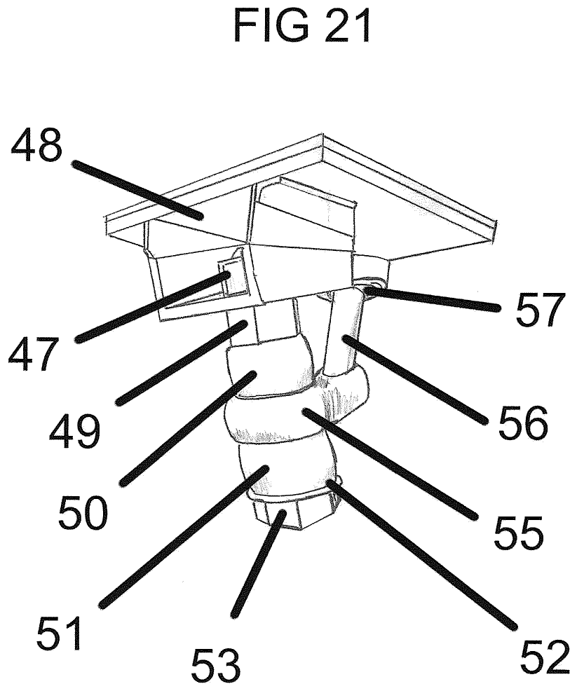

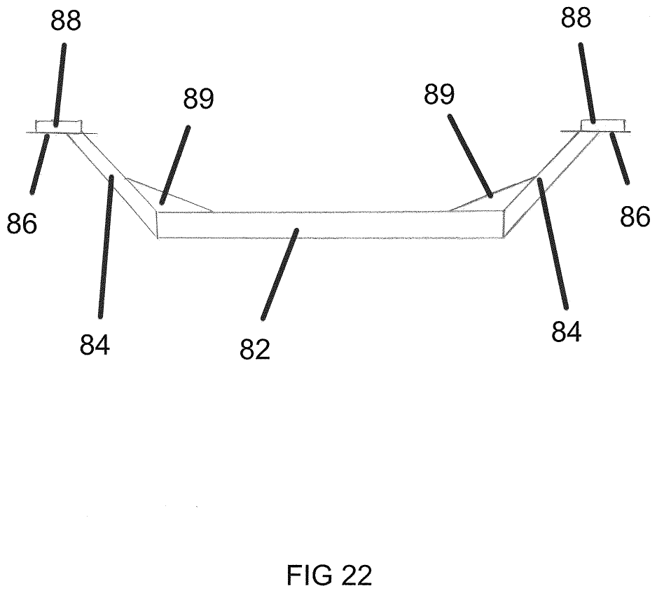

### IV. DETAILED DESCRIPTION

This embodiment (FIG.) 1 is a form of ground transportation. That's purpose is transporting a person from one place to another. Be it standing or sitting while riding in a forward or backward direction on the top surface of embodiment (FIG.) 1. While holding the control bar (30) in your hands that has an acceleration thumb throttle lever (43). For rotational energy propelling this embodiment (FIG.) 1 forward or backward by way of a motor (14) be it electric or gas. That is connected to the drive axle (16) with a chain like a dirt bike chain. Creating rotational energy movement of the tires (3)(38) propelling this embodiment (FIG.) 1 land vehicle forward or backward, the control bar (30) also has a turn signal switch (45) for signaling to other vehicles of turning left or right by the activation of turn signals (44)(22). The control bar (30) is equipped with an electrical signal brake light switch activated by the pulling in of the brake lever (37). For signaling stopping or slowing the embodiment (FIG.) 1. This embodiment (FIG.) 1 has a headlight (34) for seeing at night with a on off switch on the control panel (18).

The embodiment (FIG.) 1 has a control panel (30) with a keyed ignition (64) that sends an electrical signal to the electric starter that will start the motor. (70) But it is not limited to and may also have a kick starter for starting the motor. With the control bar (30) in your hand while standing or sitting on the flat top of this embodiment (FIG.) 1 between the front and rear. You shift up into to higher gears pulling up on the hand shifter linkage (12) and you shift down pushing down on shift linkage (12) into lower gears or reverse for backing up. Then pressing forward on the thumb throttle (43) on the control bar the motor will increase rpm rev up and initiate rotational energy propelling the embodiment (FIG.) 1 in the motion of forward or backward travel.

The embodiments (FIG.) 1 main frame (26) is connected to the rear subframe (10) by the rear steering damper system (32) welded or bonded using or other means. Which is then bolted to the main frame (26). Which articulates, rotates up to the right and up to the left by leaning forward or backward or side to side in the direction of desired travel along ground surface. The main frame (26) is bolted to the front steering damper system (32) which is bolted with the steering damper main control bolt (53) to the swivel actuator arm of the front fork assembly. Which articulates, rotates up to the right and up to the left by leaning forward or backward or side to side in the direction of desired travel along ground surface. The steering damper system's frame plate (48) is connected by the main bolt (53) that passes through washer (52), through the compression bushing (51), through the swivel actuator arm (55), through the second compression bushing (50), through the steering damper tension adjustment nut (49), mounted to the steering damper frame plate (48), held in place with the steering damper hold nut (47).

The swivel actuator arm has the steering damper actuating stud (56), welded to it. The steering damper actuator stud is pressed inside the swivel bearing (57).

The front and rear steering suspension springs (24) have welded round mounts on the ends of the main frame (26) front and rear, also on the ends of the shoulders of the front fork system (46) and the rear subframe system (10) to secure the springs. These front springs (42) and rear springs (24) create increased tension when compressed by leaning in the direction of said springs. When the operator leans back up to straighten out these front and rear steering suspension springs (24)(42) assist in pushing the front fork assembly and rear subframe assembly straight and realigned for forward or backward travel.

The front fork assembly (46) and rear subframe (10) are made of square and round metal tubing but not to be limited to these materials and may be made of other materials such as aluminum or a poured metal cast. The front fork assembly (46) and the rear subframe (10) are welded and or bond at all joints/intersections of structural metal or other material used. The same construction as the main frame. The front and rear axle (40)(16) are made of round metal tubing cut to size but not limited to 6 inches to 20 inches more or less if need be. With welded or bonded plate mounts made of the same metal or like material. For mounting to the rim (38)(3), sprocket (5), and disc brake (2).

The motor (14) is mounted, bolted down to the top plate of the rear subframe (10). The rear axle is bolted to the lower section of the rear subframe's (10) mounts. The motor is connected to the jackshaft (73) with the drive sprocket on the motor to the drive sprocket on the jackshaft (73) by a chain which is connected by the steel shaft on the jackshaft (73) to the secondary output sprocket which is connected to the rear drive sprocket (5) with another separate chain similar to a dirt bike chain, that is bolted to the rear axle (16) and tire/rim (3).

When shifted into gear by the shift linkage (12) you depress the thumb throttle (43), increasing the rpm of the motor (14) that engages the transmission which is part of the motor casing. But not limited to the motor (14) and transmission being in the same casing they could as an example be separate cases that are bolted together. This will turn the motor sprocket and chain connected to the jackshaft sprocket that transfers rotational energy to the jackshafts output sprocket that transfers torque rotational energy to the drive axle sprocket transferring rotational energy to the rear tire propelling the embodiment (FIG.) 1 forward or backward along a ground surface.

This embodiment (FIG.) 1 has left and right front and rear crash damper handles (20), for safety and protection of said embodiment (FIG.) 1. Incase this embodiment were to roll on its side these crash damper handles would hit first stopping the motor from hitting the ground. This embodiment also has a second safety feature to assist in stabilizing the said embodiment (FIG.) 1. These are front and rear stabilizer wheels that will hit the ground and start rolling and stop said embodiment (FIG.) 1 from tipping over if the operator were to lose control and lean too far.

### REFERENCE NUMBER DETAIL

FIG'S 1-22
2. Rear disc brake disc.
3. Rear tire and rim.
4. Rear brake light/taillight.
5. Rear drive sprocket.
6. Rear stabilizer wheels.
7. Rear steering damper system.
8. Brake caliper.
10. Rear subframe.
11. Rear axle plate.
12. Hand shifter linkage.
13. Front axle mount plate.
14. Engine/motor.
16. Rear axle.
18. Control panel.
20. Rear crash damper handles.
22. Rear turn signal.
24. Rear steering suspension spring.
26. Main frame.
28. Battery.
29. Control bar harness.
30. Control bar.
31. Control bar leash.
32. Front steering damper system.
33. Throttle cable.
34 Front headlight.
35. Master cylinder reservoir.
36. Front crash damper handles.
37. Rear brake lever.
38. Front tire and rim.
39. Throttle assembly.
40. Front axle.
41. Tethered kill switch leash.
42. Front steering suspension spring/shocks.
43. Thumb throttle.
44. Front turn signal.
45. Turn signal switch.
46. Front fork assembly.
47. Steering damper hold nut.
48. Steering damper frame plate.
49. Steering damper tension nut.
50. Compression bushing.
51. Compression bushing.
52. Washer.
53. Steering damper main control bolt.
55. Swivel actuator arm.
56. Steering damper actuating stud.
57. Swivel bearing.
60. Power/Ignition/Secondary kill switch to motor.
62. Light activation switch.
64. Keyed ignition.
66. Digital gear indicator.
68. Carburetor/air cleaner/filter.
70. Starter.
72. Fuel filter.
74. Top subframe.
76. Crankshaft vent.
78. Exhaust/muffler.
80. Gas tank.
81. Jackshaft, motor to axle attachment.
82. Fuel pump.
83. Main frame side rail.
84. Front and rear a frame.
86. Mount plate.
88. Cross member.
89. Support gussets.

1. A motorized self-propelled vehicle comprising:
a. A steel/metal tubing frame. With welded intersections.
b. Left and right frame rails with a flat metal sheet welded on top for sitting or standing. With right and left A frame tubes that are mounted at the front and back with a welded cross member and mount plate. For bolting on the front fork assembly and steering damper and the rear subframe and steering damper.

4. The front fork assembly comprises:
a. A welded u shaped for made of steel tubing that attaches to the steering damper system and to the main frame. With a rim and tire mounted at the ends of the fork axle mount plates. For forward or backward travel along a ground surface.

6. The rear subframe comprises:
a. A triple link of steel tubing all mounted, welded to the rear axle mount plate.
b. Has a right and left side of triple links of steel tubing that span from the axles mount plate to the top mount plate where the motor is mounted.
c. Also connected, welded to the link that connects to the rear steering damper system and to the main frame.
d. With a rim and tire mounted at the ends of the rear axle mount plates. For forward or backward travel along a ground surface.

11. The front and rear steering damper systems steer/turn said vehicle left or right by leaning on the left or right side of the main frame. 1. While rotationally traveling forward or backward, and comprises:
a. A main control bolt that passes through a washer, compression bushing, swivel actuator arm, compression bushing, tension adjustment nut, held in place by the frame plate, tightened and secured with the hold nut.
b. The steering damper actuating stud is welded into the top of the arm of the actuator arm. Which is then pressed into the swivel bearing that rotates and swivels which enable the turning of said embodiment.
c. The swivel bearing is seated and held into place by a round steel sleeve section of tubing that is welded to the frame plate.

15. The front and rear steering suspension springs/shocks comprise:
a. The springs/shocks are made of metal and are held in place being pressed over or pressed into round sleeve tubing or pipe mounts on each of the 4 corners of the A frame ends of the main frame. And the outside corners, of the front fork assembly and the rear subframe to control compression.
b. The front and rear spring/shocks can be changed for a softer less tension spring/shock or a stiffer more tension spring/shock.

18. Motor, transmission, jackshaft, axle link connections comprise:
a. The motor is a combustion motor but not limited to and may also be electric or hybrid.
b. The transmission is connected and part of the same casing as the motor but not limited to and may also be separate casings.
c. The motor has an output sprocket but not limited to and may also be a device that holds a belt for belt drive. This sprocket has a chain that transfers rotational energy to a jackshaft, then to rear tire/axle.

22. Jackshaft with chain and sprocket connections.
a. The jackshaft has an input sprocket and chain connected to the output sprocket on the motor for transferring rotational energy from the motor to the jackshaft.
b. The jackshaft has a shaft that the input sprocket is bolted to that transfers rotational energy from the input sprocket to the output sprocket.
c. The output sprocket transfers rotational energy by a second chain to the rear drive sprocket connected/bolted to the rear tire and wheel completing the rotational energy transfer from the motor to jackshaft to rear tire and wheel propelling said embodiment, land vehicle (Dual Sport Board) forward or backward in directional ground travel.

26. The control bar comprises:
a. The bar that can be any length, width or diameter.
b. A thumb throttle and lever for increasing or decreasing forward or backward rotational ground travel.
c. A hydraulic brake, master cylinder and brake lever with integrated electronic brake switch activated by pulling the lever. The brake lever is squeezed transferring brake pressure hydraulic line to the brake caliper that squeezes the brake disc attached to the rear axle but not limited to and could be attached to the front axle. When squeezed, activated the brake will slow or stop said vehicle activating the brake the brake light.
d. A tethered kill switch. Attaches to your wrist so if you fall off the embodiment it will pull the connection apart and stop the motor from running.
e. A turn signal switch with a left and a right button you press to activate signaling turning left or right.
f. Could also have an electrical switch to the electric gear shifter. You press an up or down button to shift gears up or down.

33. The control panel comprises:
a. Keyed ignition.
b. Power switch to turn on the electrical to begin startup of motor.
Ignition/push button start.
And a secondary kill switch to turn the motor off.
c. Digital gear indicator. Indicating what gear, you are in.
d. Headlight and running light switch.

38. Rear stabilizer wheels comprises:
a. A frame mount and pneumatic tire for catching said embodiment when leaned too far so it doesn't tip over. Can be adjusted, moved along the mount rail to allow said embodiment to lean more or less for control. Also, can be removed allowing said embodiment to lean at a greater angle. By removing the mounting hardware and bolts.

40. Alternatives, even though this embodiment is made of steel. It could also, but not limited to be made of aluminum or a poured cast in pieces or one piece.
